(19) United States
(12) Patent Application Publication
(10) Pub. No.: US 2002/0059311 A1
(43) Pub. Date: May 16, 2002

(54) Cooking recipe providing system and computer readable recording medium with cooking recipe providing program

(76) Inventor: Masao Nishina, Tokyo (JP)

Correspondence Address: WELLS ST. JOHN P.S., 601 W. FIRST, SUITE 1300, SPOKANE, WA, 99201-3828, US

(21) Appl. No.: 09/898,657

(22) Filed: Jul. 2, 2001

(30) Foreign Application Priority Data
Aug. 10, 2000 (JP) 2000-242797

(51) Int. Cl. G06F 7/00

(52) U.S. Cl. 707/200

(57) ABSTRACT

A cooking recipe providing system or a computer readable recording medium for providing a predetermined cooking recipe from at least one food material data including a name and a quantity of the food material, uses a database which stores in advance a plurality of cooking recipes and food material data corresponding to the cooking recipes. A plurality of the food material data in which priorities are set are provided to the cooking recipe providing system. First cooking recipes of meals using all the food materials of the plurality of the food material data provided are searched from the database. Second cooking recipes of meals in which the food material of the highest priority is a main food material are selected from the first cooking recipes. At least one cooking recipe of the second cooking recipes is provided.

### RELATED APPLICATIONS

This application relates to and claims priority to corresponding Japanese Patent Application No. 2000-242797 filed on Aug. 10, 2000.

### BACKGROUND OF THE INVENTION

1. Field of the Invention

The present invention relates to a system for providing a cooking recipe, and more particularly to a cooking recipe providing system and a computer readable recording medium, on which a cooking recipe providing program is recorded, for providing a predetermined cooking recipe based on a plurality of food materials (food material data) which are input from the outside.

2. Description of the Related Art

Conventionally, the cooking recipe was provided in a form of printed matters such as cooking recipe books, and usually homemakers decided a menu of dinner, etc. from the cooking recipe books. Then, food materials for meals (menu) were purchased in accordance with the cooking recipe. Also, in recent years, there are computer programs for providing the cooking recipe on a personal computer with the development of personal computers.

However, in the case where the food materials are purchased after deciding the menu by the cooking recipes, there unavoidably remain leftover food materials. This is because the food materials are usually sold in a “pack” at a market such as a supermarket, the homemakers cannot help purchasing the food material with a quantity over that of the food material written on the cooking recipe. Such leftover food materials were used in other meals, or become spoiled. Here, in the case where the homemakers think of effectively using the leftover food materials in other meals, it has not been possible for them to search by the conventional cooking recipe books as to what can be made from the leftover food materials. That is, although the names and the quantities of the food materials necessary for the meals are available from the meals by the conventional cooking recipe books, the meals cannot be known from the food materials. This is the same as in the case where the homemakers think what can be made from the food materials which are sold as a bargain sale at a supermarket, etc.

In view of the above circumstances, the present invention relates to a cooking recipe providing system and a computer readable recording medium with a cooking recipe providing program for providing a cooking recipe which can be made from leftover food materials in a refrigerator, food materials sold as a bargain sale, etc.

### SUMMARY OF THE INVENTION

An object of the present invention, therefore, is to overcome the problems existing in the prior art, and to provide a cooking recipe providing system for providing a predetermined cooking recipe from at least one food material data. The system has a database which stores in advance a plurality of cooking recipes and food material data including names and quantities of food materials corresponding to the cooking recipes. The cooking recipe providing system is characterized in that: a plurality of the food material data in which priorities are set are provided to the cooking recipe providing system; first cooking recipes of meals using all food materials of the plurality of the food material data provided are searched from the database; second cooking recipes of meals in which the food material of the highest priority is a main food material are selected from the first cooking recipes; and at least one cooking recipe selected from the second cooking recipes is provided.

If there is no meal using all the food materials of the plurality of the food material data provided, third cooking recipes of meals may be searched by removing from searching parameters low priority food material data in which a priority of a food material is low among the food materials of the plurality of the food material data, and fourth cooking recipes of meals using the food materials of the low priority food material data removed from the searching parameters may be searched, and at least two cooking recipes may be provided.

Further, a food material list, which includes lacking food material data of lacking food materials among food materials used for making the meals of the searched cooking recipe, may be provided.

Moreover, a cooking method of the meal of the searched cooking recipe may be provided by still images or movie images.

Still further, the cooking recipe providing system is provided on a communication network, the food material data are provided to the system through the communication network, and the cooking recipe selected from the second cooking recipes is provided through the communication network.

According to another aspect of the invention, there is provided a computer readable recording medium with a cooking recipe providing program for providing a predetermined cooking recipe from data of at least one food material, and using a database which stores in advance a plurality of cooking recipes and food material data including names and quantities of food materials corresponding to the cooking recipes. The computer readable recording medium is characterized in that: a plurality of the food material data in which priorities are set are provided to the cooking recipe providing program; first cooking recipes of meals using all food materials of the plurality of the food material data provided are searched from the database; second cooking recipes of meals in which the food material of the highest priority is a main food material are selected from the first cooking recipes; and at least one cooking recipe selected from the second cooking recipes is provided.

The database may be stored in the computer readable recording medium, or provided on a communication network and accessed through the communication network.

According to the invention, the effect in which it is possible to make meals easily by using leftover food materials or food materials sold as a bargain sale, can be obtained. Also, even if a plurality of food materials are used, by designating the most main food material data of all, the cooking recipe in which this designated food material is the main food material can be provided, so that by making the meals in which the large quantity of leftover food material or the food material bought excessively is the main food material, the effect in which it is possible to consume effectively the food materials can also be obtained.

By providing the database on the communication network, an update of the database can easily be made, so that since it is possible to deal with popular food materials, etc. timely, the effect in which users do not lose interest can also be obtained.

### BRIEF DESCRIPTION OF THE DRAWINGS

The above and other objects, features and advantages of the present invention will be apparent from the following description of preferred embodiments of the invention explained with reference to the accompanying drawings, in which:

FIG. 1 is a schematic block diagram showing a food recipe providing system according to the invention; and

FIG. 2 is a flow chart for explaining a flow of a food recipe providing system according to the invention.

### PREFERRED EMBODIMENTS OF THE INVENTION

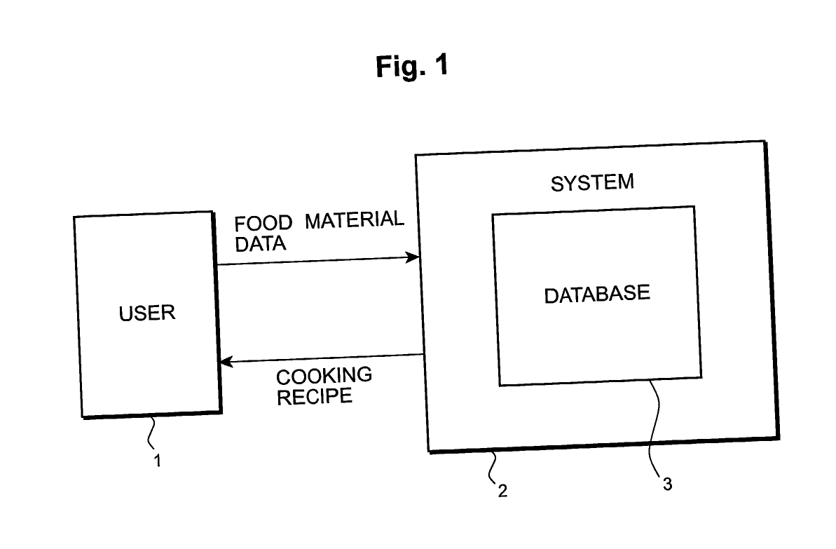

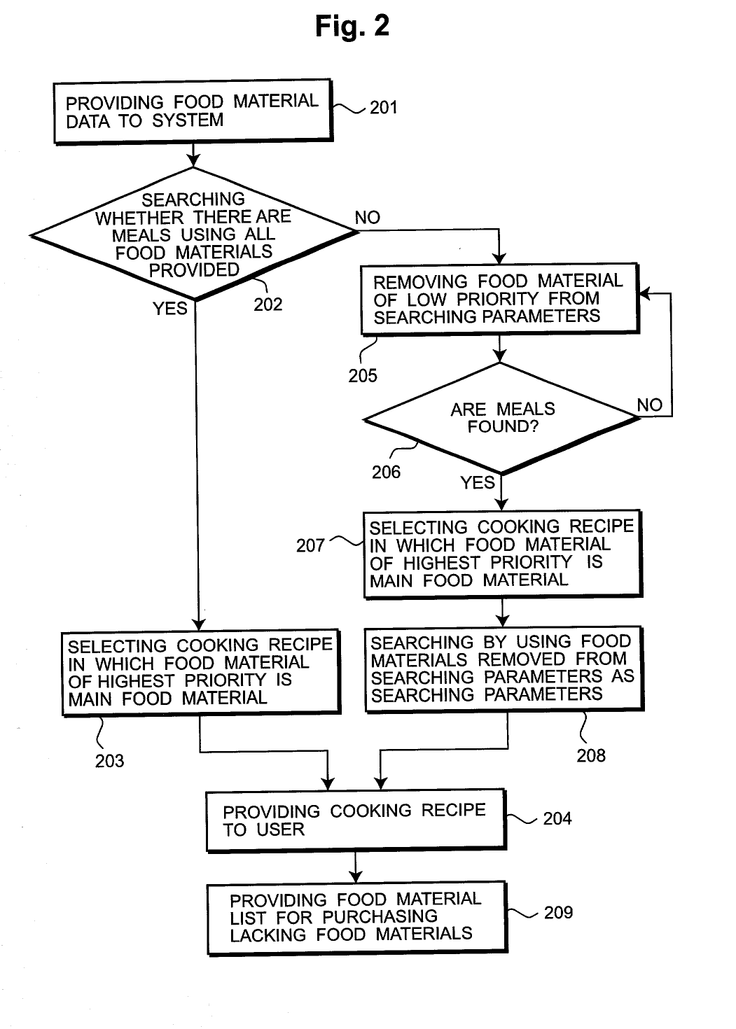

Now, embodiments according to the invention are explained with reference to the drawings. FIG. 1 is a block diagram for schematically showing a cooking recipe providing system according to the present invention. The outline is one in which a user 1 of this system gives food material data including names or quantities of food materials, etc. to a cooking recipe providing system 2, and then a cooking recipe of a meal which can be made by using the searched food materials is provided to the user 1 from a database 3 provided within the cooking recipe providing system 2. Such system is provided on, for example, such a communication network as a typical example of the Internet, and the user 1 can obtain the cooking recipes by accessing to this system via the communication network. Specifically, a cooking recipe providing web site is built on the Internet, and the user accesses to such site by using a web browser, etc. on a personal computer of the user. Also, a cooking recipe providing computer program may be installed into the personal computer of the user, and the user may obtain the cooking recipes from this program. In this case, the database may be recorded, together with the program, on a recording medium such as CD-ROM or DVD-ROM readable by the computer in which the cooking recipe providing program is installed. However, where only the database separated from the program is provided on the communication network, the database can always be updated, so that a new cooking recipe, etc. can easily be added into the database. Hereunder, the detailed explanation is made by using FIG. 2.

FIG. 2 is a flow chart for explaining a flow of the cooking recipe providing system according to the present invention. First, the user 1 provides food material data including names, quantities, etc. of food materials to the system 2 (step 201). Specifically, the names and quantities of the food materials are provided, which are leftover in a refrigerator or sold as a bargain sale at a supermarket. Preferably, other additional data such as the number of persons served is simultaneously provided. Also, in the case where there are many kinds of the food materials to be provided to the system 2, priorities of the food materials are set. Specifically, when, for example, “potato” and “onion” exist, and if the user wants to eat a meal in which the “potato” is the most main food material of all, the priorities are set such that the “potato” is numbered as “1” and the “onion” is numbered as “2”. The setting of the priorities can also be made in the order in which the food material data are input in columns, i.e., the earlier the food materials data are input, the higher the priorities are set. In this case, the food material input first is of the highest priority. Also, the food material input to the system 2 may be one. The term “main food material” in the present specification may include a food material which is used with most quantity in the meal as well as a food material which is main food (main dish).

In the step 202, the search (retrieval) into the database 3 is conducted as to whether there are meals which use all the many food materials input at the step 201. Each food material is stored as electrical data in the database 3 such that each food material is related to meals. Therefore, it is possible to search not only food materials from meals, but also meals from food materials, that is, the reverse search can be conducted. Needless to say that the search of food materials from meals can be conducted in the same way as in the conventional example. Here, the search may be conducted as Boolean search of AND in which all the food material data are of the searching parameters such that meals in which all the many food materials provided in the step 201 are used can be searched.

As a result of the search in the step 202, in the case where many meals which use all the many food materials provided are found, a cooking recipe of a meal in which the food material of the highest priority is the main food material is selected from the searched result (step 203). For example, in the case where “potato” and “onion” are provided to the system as above, when meals such as “curry”, “stew” or “boiled-and-seasoned potato-and-pork (hereinafter referred as “nikuzyaga” as in Japanese)” are picked up as the searched result, and in the case where the priority of the “potato” is higher, the cooking recipe of the “nikuzyaga” in which the “potato” is the main food material is selected. Then, the selected cooking recipe is provided to the user 1 (step 204). Needless to say, not only one cooking recipe, but also other cooking recipes in the searched result (for example, the cooking recipes of “curry” or “stew”) may also be provided together therewith. In this case, the cooking recipes of the meals are preferably provided in the order of higher priorities of the main food materials. Also, when the food materials provided to the system 2 are not used as main food materials (for example, such condiments as seasonings or spices), meals using such food materials may be selected even if such food materials are not the main food materials. In this case, other searching parameters, for example, “Japanese food”, “Western food”, “Chinese food”, “sweet”, “hot”, “light”, “heavy”, etc. may desirably be added. By adding such searching parameters, cooking recipes of meals can be provided in accordance with the user's taste.

On the other hand, in the step 202, in the case where no meals using all the food materials are searched, a combination of many meals is provided so that all the food materials provided can be used. That is, the food materials are removed from the searching parameters in the order of low priorities of the food materials (step 205), and this is repeated until any meal is found (step 206). Then, if meals are found, and in the case where many meals are found, a cooking recipe of a meal in which the food material of the highest priority is the main food material is selected in the same way as in the step 203 (step 207).

Next, only the food materials removed from the searching parameters in the step 205 are used as the searching parameters, cooking recipes using the removed food materials are searched from the database 3, and a cooking recipe of a meal in which the food material of the highest priority among the food materials removed from the searching parameters is the main food material is selected (step 208). Then, each of the cooking recipes selected at the steps 207 and 208 is provided to the user 1 (step 204). In the case where many food materials removed from the searching parameter exist, and if there is no meal using all the removed food materials, the food materials may preferably be removed from the searching parameters in the order of low priorities of the food materials by returning to the step 205 repeatedly.

More specifically, in the case where, for example, “cucumber” and “seaweed” as well as “potato” and “onion” are provided to the system, when a meal using all the food materials is not found by Boolean search of AND from the database 3, first, the “seaweed” which is the lowest priority is removed from the searching parameters (step 205), and then the searching is conducted (step 206). In this case, if the meal using all the food materials is not found yet, the “cucumber” which is the secondly lower priority is removed (step 205). Then, the searching is conducted with “potato” and “onion” (step 206). Here, if meals such as “curry”, “stew” or “nikuzyaga” are found as the searched result, the “nikuzyaga” in which the “potato” of the highest priority among the provided food materials is a main food material is selected (step 207). Further, the searching is conducted with which the “cucumber” and the “seaweed” removed from the searching parameters are used as the searching parameters. As a result, for example, “vinegared food” is selected (step 208). From the above, the cooking recipes of “nikuzyaga” and “vinegared food” are provided to the user 1 (step 204).

Also, if the food materials provided are not used as main food materials (for example, such condiments as seasonings or spices), it is also possible to provide a plurality of cooking recipes of meals using such food materials. In this case, searching parameters other than the food material data are preferably added. Various parameters, for example, “Japanese food”, “Western food”, “Chinese food”, “sweet”, “hot”, “light”, “heavy”, etc. are applicable to the searching parameters. By adding such parameters, it is possible to provide cooking recipes of meals in accordance with a taste of the user 1.

When the cooking recipe is provided, it is also possible to provide simultaneously a cooking method by still images or movie images. The data of the still images or movie images are preferably stored in the database 3 in advance.

Here, if the cooking recipe of the meal, which can be made by only the food materials provided to the system, can be provided, there is no problem. However, food materials sometimes exist, which are to be additionally purchased for making the searched meals. In the above example, when the “nikuzyaga” is made, “pork” in addition to the “potato” and “onion” is also necessary. Therefore, a food material list for an additional purchase, which includes names of food materials to be additionally purchased and quantities thereof, may be provided (step 209). By doing so, the homemaker may confirm the food material list and may purchase lacking food materials in necessary quantities. The meal may be cooked in accordance with the searched cooking recipe, but it is also possible to provide other cooking recipes by further changing the parameters.

Also, the described food materials or meals in the specification are just examples of food materials or meals, thus, needless to say, the present invention is not limited to the above examples.

As has been described in the foregoing, according to the cooking recipe providing system of the present invention, since it is possible to provide cooking recipes of meals which can be made by using leftover food materials in a refrigerator or food materials sold as a bargain sale, the present invention is effective in that food materials are efficiently consumed.

Also, by providing the database on the communication network, an update of the database can easily be made, so that since it is possible to make an instantaneous updating to deal with the latest meals, popular food materials, etc., the interest of the user is kept attracted.

While the invention has been described in its preferred embodiment, it is to be understood that the words which have been used are words of description rather than limitation and that changes within the purview of the appended claims may be made without departing from the true scope of the invention as defined by the claims.

What is claimed is:

1. A cooking recipe providing system for providing a predetermined cooking recipe from data of at least one food material including a name and a quantity of the food material, said system having a database which stores in advance a plurality of cooking recipes and food material data corresponding to said cooking recipes, said cooking recipe providing system being characterized in that:
a plurality of said food material data in which priorities are set are provided to said cooking recipe providing system;
first cooking recipes of meals using all the food materials of said plurality of said food material data provided are searched from said database;
second cooking recipes of meals in which the food material of the highest priority is a main food material are selected from said first cooking recipes; and
at least one cooking recipe of said second cooking recipes is provided.

2. The cooking recipe providing system according to claim 1, which is further characterized in that, if there is no meal using all the food materials of said plurality of said food material data provided, third cooking recipes of meals are searched by removing low priority food material data in which a priority of a food material is low among said food materials of said plurality of said food material data, and fourth cooking recipes of meals using the food material of said low priority food material data removed from said searching parameters are searched, and at least two cooking recipes are provided.

3. The cooking recipe providing system according to claim 1, which is further characterized in that a food material list, which includes lacking food material data of lacking food materials among the food materials used for making the meals of the searched cooking recipe, is provided.

4. The cooking recipe providing system according to claim 1, which is further characterized in that a cooking method of the meal of the searched cooking recipe is provided by still images or movie images.

5. The cooking recipe providing system according to claim 1, in which said system is provided on a communication network, said food material data are provided to said system through said communication network, and said at least one cooking recipe of said second cooking recipes is provided through said communication network.

6. A computer readable recording medium having a cooking recipe providing program for providing a predetermined cooking recipe from data of at least one food material including a name and a quantity of the food material, and using a database which stores in advance a plurality of cooking recipes and food material data corresponding to said cooking recipes, said computer readable recording medium being characterized in that:
a plurality of said food material data in which priorities are set are provided to said cooking recipe providing program;
first cooking recipes of meals using all the food materials of said plurality of said food material data provided are searched from said database;
second cooking recipes of meals in which the food material of the highest priority is a main food material are selected from said first cooking recipes; and
at least one cooking recipe of said second cooking recipes is provided.

7. The computer readable recording medium according to claim 6, which is further characterized in that, if there is no meal using all the food materials of said plurality of said food material data provided, third cooking recipes of meals are searched by removing low priority food material data in which a priority of a food material is low among said food materials of said plurality of said food material data, and fourth cooking recipes of meals using the food material of said low priority food material data removed from said searching parameters are searched, and at least two cooking recipes are provided.

8. The computer readable recording medium according to claim 6, which is further characterized in that a food material list, which includes lacking food material data of lacking food materials among food materials used for making the meals of the searched cooking recipe, is provided.

9. The computer readable recording medium according to claim 6, which is further characterized in that a cooking method of the meal of the searched cooking recipe is provided by still images or movie images.

10. The computer readable recording medium according to claim 6, in which said database is stored in said computer readable recording medium.

11. The computer readable recording medium according to claim 6, in which said database is provided on a communication network, and accessed through said communication network.
